(19) United States
(12) Patent Application Publication
(10) Pub. No.: US 2020/0254390 A1
(43) Pub. Date: Aug. 13, 2020

(54) DIFFUSIOPHORETIC WATER FILTER WITH DISPOSABLE MEMBRANES AND METHOD

(71) Applicant: Split Rock Filter Systems LLC, New Paltz, NY (US)

(72) Inventor: William C. Gehris, New Paltz, NY (US)

(21) Appl. No.: 16/788,626

(22) Filed: Feb. 12, 2020

Related U.S. Application Data
(60) Provisional application No. 62/804,712, filed on Feb. 12, 2019.

(51) Int. Cl. B01D 65/02; B01D 71/68; C02F 1/44

(52) U.S. Cl. CPC B01D 65/025; C02F 2303/16; C02F 1/44; B01D 71/68

(57) ABSTRACT

A method for operating a diffusiophoretic water filter includes removing a membrane in a diffusiophoretic water filter; and replacing the membrane with a new membrane.

This claims the benefit of U.S. Provisional Patent Application 62/804,712, filed on Feb. 12, 2019 which is hereby incorporated by reference herein.

Applicants also incorporate International Patent Application PCT/US19/65976, filed on Dec. 12, 2019 by reference herein.

### BACKGROUND

One issue with large scale diffusiophoretic water filters is cleaning or blockage of the small diffusiophoretic channels. The use of cleaning solutions or even of splitting membranes apart and cleaning for example by high pressure clean water can be time consuming and expensive.

### SUMMARY OF THE INVENTION

One unexpected advantage of the easily manufactured diffusiophoretic water filters for example as disclosed in PCT/US19/65976, is that the cost of simply removing and replacing the diffusiophoretic membrane with a newly manufactured one surprisingly can be less than the actual cleaning or maintenance cost. Such replacement also is more hygienic as mold, bacteria and other particulates which may accrue in the diffusiophoretic channels is 100% percent removed.

### DESCRIPTION OF THE INVENTION

The present invention thus provides for a method for operating a diffusiophoretic water filter comprising:

removing a membrane in a diffusiophoretic water filter; and

replacing the membrane with a new membrane.

The membrane preferably is a PDMS membrane.

The membrane preferably is larger than 10 cm in width and 10 cm in length.

The membrane preferably has diffusiophoretic channels therein, most preferably manufactured by lasers, as disclosed in PCT/US19/65976.

The new membrane preferably has an exact same structure as the membrane and is manufactured in the same way.

The membrane and new membrane preferably are manufactured at a diffusiophoretic water filter plant, from a roll of PDMS material.

The membrane may be made from a sheet of PDMS material at least 1 mm thick, and permit CO2 permeability.

The membrane preferably is removed from a support, for example a plastic support that permits air or CO2 to access the membrane.

If more than one membrane is present, for example two membranes placed over each other to define diffusiophoretic water channels, one or both of the membranes may be removable and replaceable by the new membranes.

The new membranes preferably have never been used for water filtration previously. The new membranes preferably are fully sterile.

The membrane preferably is recycled for its PDMS material, or cleaned in a cleaning solution, mechanically and/or by steam for later reuse as a new membrane. This cleaning has no time constraints and does not impact the downtime of the diffusiophoretic water filter. The membrane also may be discarded.

What is claimed is:

1. A method for operating a diffusiophoretic water filter comprising:
removing a membrane in a diffusiophoretic water filter; and
replacing the membrane with a new membrane.

2. The method as recited in claim 1 wherein the membrane is discarded.

3. The method as recited in claim 1 wherein the membrane is cleaned and sterilized and reused as a further new membrane replacing a further membrane.

4. The method as recited in claim 1 further comprising removing the membrane when a certain level of fouling has occurred.

5. The method as recited in claim 1 further comprising removing the membrane after a predetermined time period.

6. The method as recited in claim 1 wherein the membrane is made of PDMS.

7. The method as recited in claim 1 wherein the membrane has diffusiophoretic water channels.

8. A method for cleaning a diffusiophoretic water filter comprising:
removing a membrane in a diffusiophoretic water filter; and
replacing the membrane with a new membrane,
no cleaning of the membrane occurring between the removing and replacing steps.
